(19) United States
(12) Patent Application Publication
(10) Pub. No.: US 2008/0243604 A1
(43) Pub. Date: Oct. 2, 2008

(54) METHOD TO DISPOSE OF COMPENSATION OFFERS ON A DIGITAL VIDEO RECORDER

(76) Inventors: Edward E. Pollard, Leander, TX (US); Kumar Ravi, Cedar Park, TX (US); Troy C. Wilson, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/693,099

(22) Filed: Mar. 29, 2007

(51) Int. Cl. G06Q 30/00

(52) U.S. Cl. 705/14

(57) ABSTRACT

A method, computer program product, and system are provided for administering earned compensation offers. A coupon administering module receives an indication that a compensation offer has been stored for a user in a data storage on a television device. The coupon administering module identifies a user device to which the compensation offer will be sent. Responsive to identifying the user device, the coupon administering module sends the compensation offer to the user device.

### BACKGROUND

1. Technical Field

The present application relates to advertising in streaming media and, in particular, to television advertising. Still more particularly, the present invention provides a method, system, and computer program product for disposing of compensation offers on digital video recording devices.

2. Description of Related Art

Some forms of television and other forms of streaming media, such as radio, Internet radio, Internet video, and the like, include advertisements to subsidize the cost of the content and, more importantly, to increase the revenue stream associated with various types of programming. Many owners of digital video recorders (DVR) or personal video recorders (PVR), which are devices that record streaming media onto solid state recordable media, such as hard disks, random access memory (RAM), or the like, use options, such as fast forward, skip, and other commands, commonly provided with the recorders to skip or advance through advertisements. While advancing through an advertisement is convenient for the user of the recorder, skipping advertisements is a source of frustration for the advertiser who purchased the advertisement. Moreover, the increased likelihood that users of such devices will not view advertisements decreases the amount of money that the advertisers are willing to spend on advertising since the cost/benefit analysis weighs against advertising on television broadcasts.

As a result, advancing through recorded advertisements impacts the business of network providers, such as cable companies and satellite networks, as well as the television networks. While network providers are working to stop DVR manufacturers from allowing the advancement feature, the DVR manufacturers are coming up with alternative means to allow viewers to view commercials at their pleasure. For example, DVR manufacturers are providing banner ads that run continuously at the bottom of the screen.

Additionally, some advertisers attempt to entice viewers to watch their advertisements by providing secret codes embedded in the advertisements that a user must look for. Then, the user has to use the code on the advertiser's Webpage to learn what benefit the user has earned. However, looking for a secret code may require the user to use a frame-by-frame advancement to find the secret code. Although these efforts assist advertisers in getting their message across to DVR users, these efforts also require the viewers to go through a great deal of effort, which in turn may not work for many viewers.

### SUMMARY

The illustrative embodiments provide a means to enable a user of a television device to view an advertisement at an appropriate and convenient speed while providing compensation offers to the user to watch the entire advertisement. Thus, the advertiser is able to present their message to the user and the user benefits from watching the advertisement by receiving the compensation offer.

The illustrative embodiments provide a method, system, and computer program product for administering earned compensation offers. The illustrative embodiments receive an indication that a compensation offer has been stored for a user in a data storage on a television device, identify a user device to which the compensation offer will be sent, and send the compensation offer to the user device, in response to identifying the user device.

Alternative illustrative embodiments determine if the compensation offer is an online redemption compensation offer for a television event, prompt the user to redeem the online redemption compensation offer in response to the compensation offer being the online redemption compensation offer, and schedule viewing of the television event in response to a positive indication from the user to redeem the online redemption compensation offer.

Other illustrative embodiments determine if the compensation offer has an expired use date, and, responsive to the compensation offer having an expired use date, discard the compensation offer from the storage data on the television device.

Still other illustrative embodiments upload the compensation offer to a provider in response to a failure to identify the user device to which the compensation offer will be sent. In these illustrative embodiments the provider prints the compensation offer as a paper compensation offer and wherein the paper compensation offer is included with a billing statement for the user.

Other illustrative embodiments leave the compensation offer stored in the data storage on the television device in response to a failure to identify the user device to which the compensation offer will be sent, receive a request from an external device to retrieve the compensation offer from the data storage, and send the compensation offer to the external device in response to receiving the request.

The illustrative embodiments may provide a data storage that stores at least one of a compensation offer earned date, a compensation offer descriptor, a compensation offer expiration date, an advertiser identifier, or compensation offer product information. The illustrative embodiments may provide a user device that is at least one of a desktop computer, a laptop computer, a provider server, a mobile device, or a network printer. Also, the illustrative embodiments may provide a television device that is at least one of a digital video recorder, a personal video recorder, a cable television receiver, or a satellite television receiver.

In other illustrative embodiments, a computer program product comprising a computer useable medium having a computer readable program is provided. The computer readable program, when executed on a computing device, causes the computing device to perform various ones, and combinations of, the operations outlined above with regard to the method illustrative embodiment.

In yet another illustrative embodiment, a system is provided. The system may comprise a processor and a memory coupled to the processor. The memory may comprise instructions which, when executed by the processor, cause the processor to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a block diagram of a data processing system in which the illustrative embodiments may be implemented;

FIG. 2 depicts a pictorial representation of a network of data processing systems in which the illustrative embodiments may be implemented;

FIG. 3 depicts a functional block diagram of a television device in accordance with an illustrative embodiment;

FIG. 4 depicts exemplary coupon coding data in accordance with an illustrative embodiment;

FIG. 5 depicts exemplary stored coupon data in accordance with an illustrative embodiment;

FIG. 6 depicts an exemplary coupon identifier in accordance with an illustrative embodiment;

FIG. 7 depicts an exemplary coupon prompt in accordance with an illustrative embodiment;

FIG. 8 depicts a flow diagram of the operation performed by a television device in obtaining a coupon in accordance with an illustrative embodiment; and

FIG. 9 depicts a flow diagram of the operation performed by a television device in administering earned coupons in accordance with an illustrative embodiment.

### DETAILED DESCRIPTION OF THE ILLUSTRATIVE EMBODIMENTS

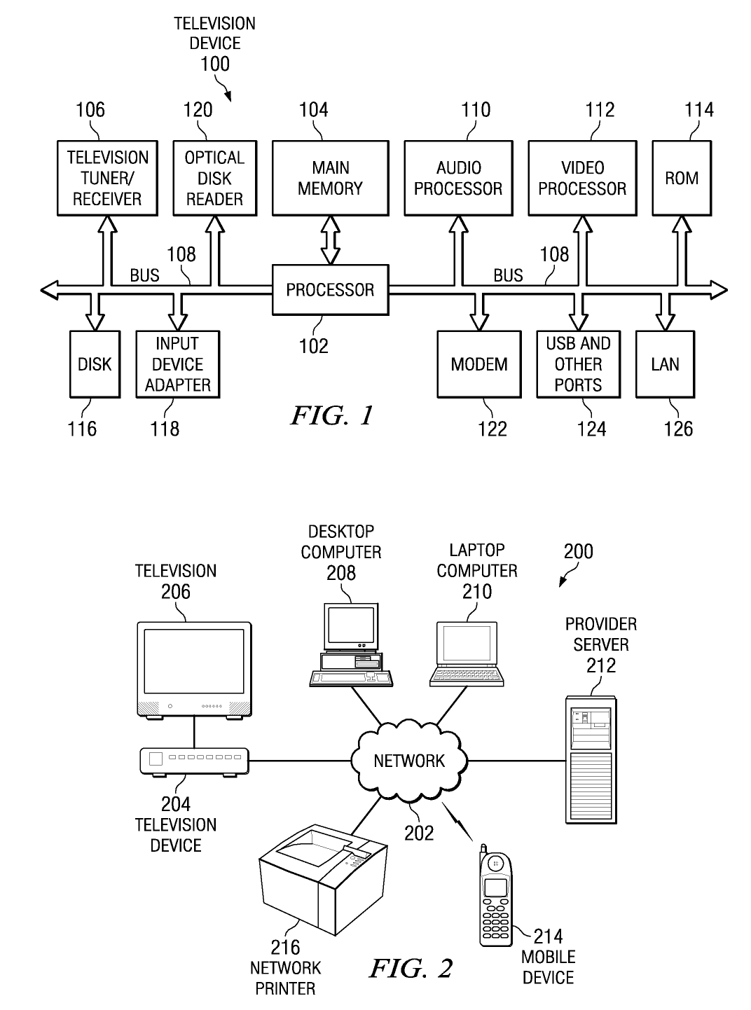

The illustrative embodiments provide mechanisms for disposing of compensation offers on digital video recording devices. With the illustrative embodiments, a data processing device used to dispose of compensation offers may be a single-processor computing device, a multiprocessing data processing system, or a virtual processor environment in which multiple processors and multiple layers of software may be utilized to perform various aspects of the illustrative embodiments. Therefore, FIGS. 1 and 2 are provided as exemplary diagrams of data processing environments in which the illustrative embodiments may be implemented. It should be appreciated that FIGS. 1 and 2 are only exemplary and are not intended to assert or imply any limitation with regard to the environments in which the illustrative embodiments may be implemented. Many modifications to the depicted environments may be made without departing from the spirit and scope of the present application.

With reference now to FIG. 1, a block diagram of a data processing system is shown in which the illustrative embodiments may be implemented. Television device 100 is an example of a television device, such as a digital video recorder (DVR), personal video recorders (PVR), cable television receiver, satellite television receiver, or the like, in which code or instructions implementing the processes of the illustrative embodiments may be located. However, television device 100 may also be a computer that is capable of streaming video from television broadcasters who provide online television programs. In the depicted example, television device 100 employs a bus architecture through which processor 102 connects to other components of the device. Main memory 104 is connected to processor 102.

Television tuner/receiver 106 is connected to processor 102 through bus 108. Television tuner/receiver 106 may be, for example, a National Television System Committee (NTSC), Advanced Television Systems Committee (ATSC) over the air (OTA) tuner. Alternatively, television tuner/receiver 106 may be a digital cable or digital satellite receiver. In yet another embodiment, television tuner/receiver 106 may be a television input port that receives an audio/video signal from an external tuner/receiver. Other receivers may also be used in place of television tuner/receiver 106, such as a satellite radio receiver, for example.

Bus 108 also connects audio processor 110, video processor 112, read-only memory (ROM) 114, disk 116, and input device adapter 118 to processor 102. Audio processor 110 may provide audio processing, such as Dolby® Pro Logic® II or Dolby® Digital surround sound decoding. Video processor 112 may perform processing, such as MPEG2 or MPEG4 decoding. Disk 116 may be a hard disk drive (HDD) for storing media content streams. Input device adapter 118 may be, for example, an infrared (IR) remote control receiver, a keyboard/mouse adapter, or the like.

Television device 100 may also include optical disk reader 120, which may be, for example, a compact disk (CD) drive, digital video disk (DVD) drive, or the like. Modem 122 may be used to dial into a server to access the Internet, retrieve program guide information, or the like. Universal Serial Bus (USB) and other ports 124 may be connected to processor 102 through bus 108. These ports may allow peripheral devices, such as printers, network adapters, etc., to be connected to television device 100. Local area network adapter (LAN) 126 may allow television device 100 to, connect to the Internet, share media content to other devices, or to acquire program guide data.

An operating system runs on processor 102 and is used to coordinate and provide control of various components within television device 100 in FIG. 1. The operating system may be a commercially available operating system such as Linux™. “LINUX” is a trademark of Linus Torvalds. Instructions for the operating system and applications or programs are located on storage devices, such as hard disk drive 116 or ROM 114, and may be loaded into main memory 104 for execution by processor 102. The processes of the illustrative embodiments may be performed by processor 102 using computer implemented instructions, which may be located in a memory such as, for example, main memory 104.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. The depicted example in FIG. 1 and above-described examples are not meant to imply architectural limitations. For example, television device 100 also may be a desktop computer, laptop computer, or telephone device in addition to taking the form of a television device.

Television device 100 may store media streams, including advertising, on disk 116. In accordance with an illustrative embodiment, television device 100 provides a means to enable the user of television device 100 to be able to view an advertisement at an appropriate and convenient speed while providing a compensation offer, such as a coupon, to the user to watch the entire advertisement. Thus, the advertiser is able to present their message to the user and the user benefits from watching the advertisement by receiving the compensation offer. The following description uses the term coupon in place of compensation offer; however, any type of compensation offer may be provided to the user.

FIG. 2 depicts a pictorial representation of a network of data processing systems in which the illustrative embodiments may be implemented. Network data processing system 200 is a network of computers in which the present invention may be implemented. Network data processing system 200 contains network 202, which is the medium used to provide communications links between various devices and computers connected together within network data processing system 200. Network 202 may include connections, such as wire, wireless communication links, fiber optic cables, or satellite.

In the depicted example, television device 204, such as television device 100 of FIG. 1, is connected to network 202 and is also connected to television 206. In addition, desktop computer 208, laptop computer 210, provider server 212, mobile device 214, and network printer 216 may be connected to network 202. Television device 204 may access desktop computer 208, laptop computer 210, provider server 212, mobile device 214, or network printer 216 through network 202. For example, once a user has viewed an entire advertisement, a coupon may be issued to the user which may be sent to the user via an electronic message to desktop computer 208, laptop computer 210, provider server 212, mobile device 214, or network printer 216.

The advertisements may include coupon descriptors that are digitally embedded in the advertisements. When television device 204 receives an advertisement, an opportunity to receive a coupon may be presented on television 206. When a user sees the opportunity and views the entire advertisement, television device 204 may send the earned coupon through network 202 to desktop computer 208, laptop computer 210, provider server 212, mobile device 214, or network printer 216.

Network data processing system 200 may include additional servers, clients, and other devices not shown. In the depicted example, network data processing system 200 is embodied within the Internet. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

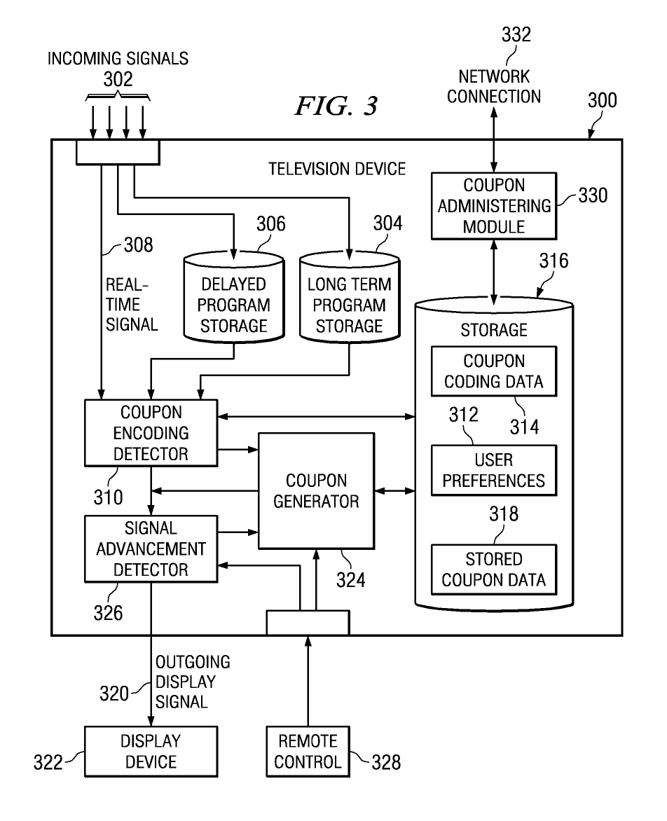

FIG. 3 depicts a functional block diagram of a television device in accordance with an illustrative embodiment. Television device 300 may be a television device, such as television device 204 of FIG. 2. Television device 300 receives incoming signals 302 that are broadcast signals from a network provider over communication connections, such as wire, wireless communication links, fiber optic cables, or satellite. It should be appreciated that the various communication connections are only exemplary and are not intended to assert or imply any limitation with regard to the communication connections the illustrative embodiments may use. Television device 300 may be set up to store incoming signals 302 in long term program storage 304, delay incoming signals 302 using delayed program storage 306, or present incoming signals 302 in real time as real-time signal 308.

Whether incoming signals 302 are stored, delayed or real-time, television device 300 includes coupon encoding detector 310 that determines if advertisements within incoming signals 302 include coupon descriptors, which are digitally embedded in the advertisements. If coupon encoding detector 310 detects a coupon descriptor within an advertisement and user preferences 312 indicates a desire of the user to obtain coupons, coupon encoding detector 310 may determine whether a promotion code associated with the coupon descriptor has been previously recorded in coupon coding data 314.

User preferences 312 and coupon coding data 314 may be stored in storage 316, which may be data storage such as main memory 104 of FIG. 1. If the promotion code associated with the coupon descriptor has not been previously recorded, coupon encoding detector 310 records the promotion code information in coupon coding data 314. Using the coupon coding data 314, coupon encoding detector 310 determines if the advertiser has placed a restriction on obtaining the coupon. Exemplary restrictions may include that the user is capable of earning only one coupon per month, only one coupon per day, or a specific number of coupons in a specific time period. Other exemplary restrictions may be based on geographic location or services subscribed. Coupon encoding detector 310 uses coupon coding data 314 associated with the coupon descriptor to determine if a coupon restriction exists. If a restriction exists, coupon encoding detector 310 uses coupon coding data 314 and stored coupon data 318 to determine if the current coupon conflicts with a previously stored coupon.

If no restriction exists or the current coupon does not conflict with a previously stored coupon, coupon encoding detector 310 uses user preferences 312 to determine if the user desires coupons of this type. That is, the user simply may not want coupons and has indicated in user preferences 312 that no coupon information should be displayed. Additionally, the user may indicate in user preferences 312 that only certain types of coupons are desired, such as those for food and dining, but not automobiles. However, if the user indicates that coupons of this type are desired, coupon encoding detector 310 adds an identifier to outgoing display signal 320 which is concurrently displayed with the advertisement with which a coupon is associated. Display device 322 displays both the identifier and the advertisement.

Once coupon encoding detector 310 adds the identifier to outgoing display signal 320, coupon encoding detector 310 sends a coupon acknowledgement to coupon generator 324. Upon receiving the acknowledgement, coupon generator 324 determines if the user has indicated in user preferences 312 a coupon storage preference. Coupon generator 324 waits until signal advancement detector 326 acknowledges that the advertisement associated with the coupon has been viewed without advancement. If the user advances through the advertisement, no coupon is generated and the user's television viewing continues uninterrupted.

If signal advancement detector 326 acknowledges that the advertisement associated with the coupon has been viewed without advancement, coupon generator 324 determines, using the previously determined coupon storage preference, to either immediately store the earned coupon in stored coupon data 318 or prompt the user for their preference to store the earned coupon.

On the initial set up of coupon usage in television device 300, coupon administering module 330 prompts the user to configure user preferences 312 for retrieving coupons. Once an earned coupon is generated by coupon generator 324 and stored in stored coupon data 318, coupon administering module 330 determines how the earned coupons will be retrieved using user preferences 312. If the user has indicated an electronic means to retrieve the earned coupon, then coupon administering module 330 may send the earned coupon using network connection 332 based on the preferred electronic means. Network connection 332 may be the same communication medium as is used by incoming signals 302 or a separate communication medium.

An exemplary electronic method may be for the coupon administering module 330 to send the coupon to a predefined email inbox residing on the user's desktop computer or laptop computer, such as desktop computer 208 or laptop computer 210 of FIG. 2. Another exemplary electronic method may be for the coupon administering module 330 to immediately display the coupon on display device 322 for immediate redemption in the case where the coupon is for a pay-per-view event. Other exemplary electronic methods may include coupon administering module 330 sending the earned coupon to a network printer, such as network printer 216 of FIG. 2, to a user's electronic folder that is associated with the user's billing account for the provider of the user's television service on a network server, such as provider server 212 of FIG. 2, or to a mobile device, such as mobile device 214 of FIG. 2.

For all electronic methods, coupon administering module 330 may send the coupons immediately or at a specific time or specific day, depending on the preferences set by the user in user preferences 312. It should be appreciated that the various methods of retrieving coupons are only exemplary and are not intended to assert or imply any limitation with regard to other means of retrieving coupons the illustrative embodiments may use.

In an alternative embodiment, if the user has not indicated an electronic means to retrieve the earned coupon, then coupon administering module 330 determines, based on information provided by the network service provider, if the network service provider is performing billing. Billing may be at whatever interval the network service provider performs billing, for example, monthly, bimonthly, quarterly, yearly, or the like. If the network service provider has not indicated that billing is being performed, then coupon administering module 330 waits for an indication from the network service provider that billing is being performed. However, if coupon administering module receives notification from the network service provider that indicates billing is being performed, coupon administering module 330 may upload the earned coupon to the network service provider's server.

Then, as the network service provider performs billing, the network service provider may print a paper copy of coupon to include with any billing documentation. Providing paper copies of a coupon may be for users who have television service from the provider but do not have an electronic means by which to obtain the earned coupon. The predetermined schedule may be stored in user preferences 312 for coupon administering module 330 to reference. Coupon administering module 330 may also monitor stored coupon data 318 to discard coupons that have expired based on the expiration date associated with the coupon that is stored in stored coupon data 318.

In another alternative embodiment, television device 300 may be configured as a network server. As depicted in FIG. 2, television device 204 may be connected to network 202. Thus, television device 300 may be configured to receive requests via network connection 332 from an external device, such as desktop computer 208 or laptop computer 210 of FIG. 2. Therefore, instead of coupon administering module 330 distributing the stored coupons to an external device, the external device may communicate directly with coupon administering module 330 to retrieve stored coupons from stored coupon data 318 on storage 316 of television device 300. Using an external device to retrieve any stored coupons allows the user flexibility in timing the retrieval of the stored coupons. That is, the user may only want to retrieve any stored coupons just prior to a shopping event, thereby not losing any coupons that may have been printed days earlier.

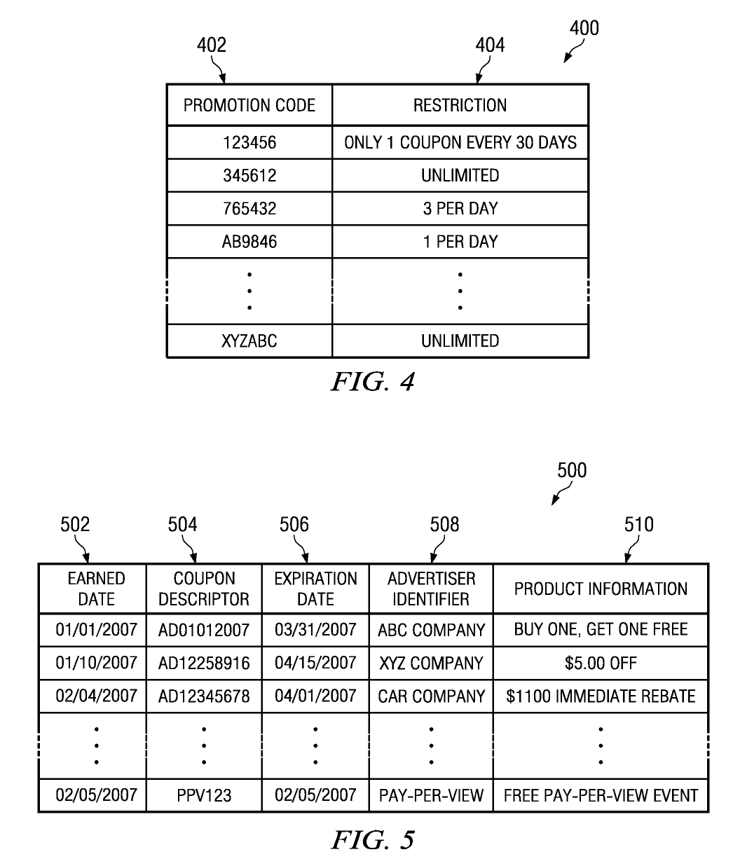

FIG. 4 depicts exemplary coupon coding data in accordance with an illustrative embodiment. Coupon coding data 400, such as coupon coding data 314 of FIG. 3, may include promotion code 402 and restriction 404. For each advertisement with a coupon descriptor, coupon coding data 400 stores the associated promotion code 402 and any restriction 404. Exemplary restrictions 404 may be that the user is capable of earning only one coupon per month, only one coupon per day, or a specific number of coupons in a specific time period. It should be appreciated that the various restrictions are only exemplary and are not intended to assert or imply any limitation with regard to the restrictions the illustrative embodiments may use.

FIG. 5 depicts exemplary stored coupon data in accordance with an illustrative embodiment. Stored coupon data 500, such as stored coupon data 318 of FIG. 3, may include coupon earned date 502, coupon descriptor 504, coupon expiration date 506, advertiser identifier 508, and coupon product information 510. Coupon earned date 502 is the date the coupon was earned by the user who watched an associated advertisement, in its entirety, which had associated coupon encoding. Coupon descriptor 504 is a unique identifier associated with the specific coupon. Coupon descriptor 504 may be used for restriction comparison. Coupon expiration date 506 is the last date the coupon may be validly redeemed with the advertiser. Advertiser identifier 508 is the name or identification of the advertiser who issued the coupon. Coupon product information 510 is information associated with the product that the coupon is for. Such as, an identifier of the product the coupon can be used for and what the coupon offers e.g. “Buy One, Get One Free”, which is the “encouragement.” It should be appreciated that the above examples of the various information that is stored are only exemplary and are not intended to assert or imply any limitation with regard to the information the illustrative embodiments may store.

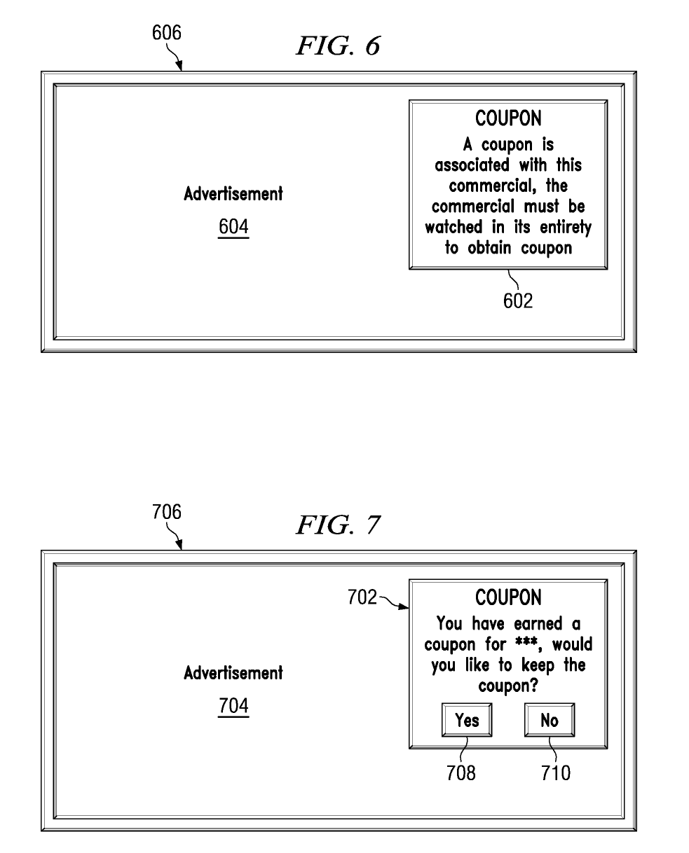

FIG. 6 depicts an exemplary coupon identifier in accordance with an illustrative embodiment. Coupon identifier 602 may be presented, for example, as a pop-up on top of advertisement 604 which is displayed on display device 606, such as display device 322 of FIG. 3. Other examples of presenting coupon identifier 602 may be to present coupon identifier 602 as a banner, a picture-in-picture, or a split screen. Coupon identifier 602 may indicate to the user that a coupon is associated with advertisement 604 and that advertisement 604 must be viewed in its entirety to obtain the coupon.

FIG. 7 depicts an exemplary coupon prompt in accordance with an illustrative embodiment. Coupon prompt 702 may be presented, for example, as a pop-up on top of advertisement 704 which is displayed on display device 706, such as display device 322 of FIG. 3. Other examples of presenting coupon prompt 702 may be to present coupon prompt 702 as a banner, a picture-in-picture, or a split screen. Coupon prompt 702 may indicate to the user that a coupon has been earned and ask the user if the user would like to keep the coupon. If the user selects “Yes” button 708 using the remote control, then the coupon generator stores the earned coupon in the stored coupon data. If the user selects “No” button 710 using the remote control, then no coupon is generated and the user's television viewing continues uninterrupted.

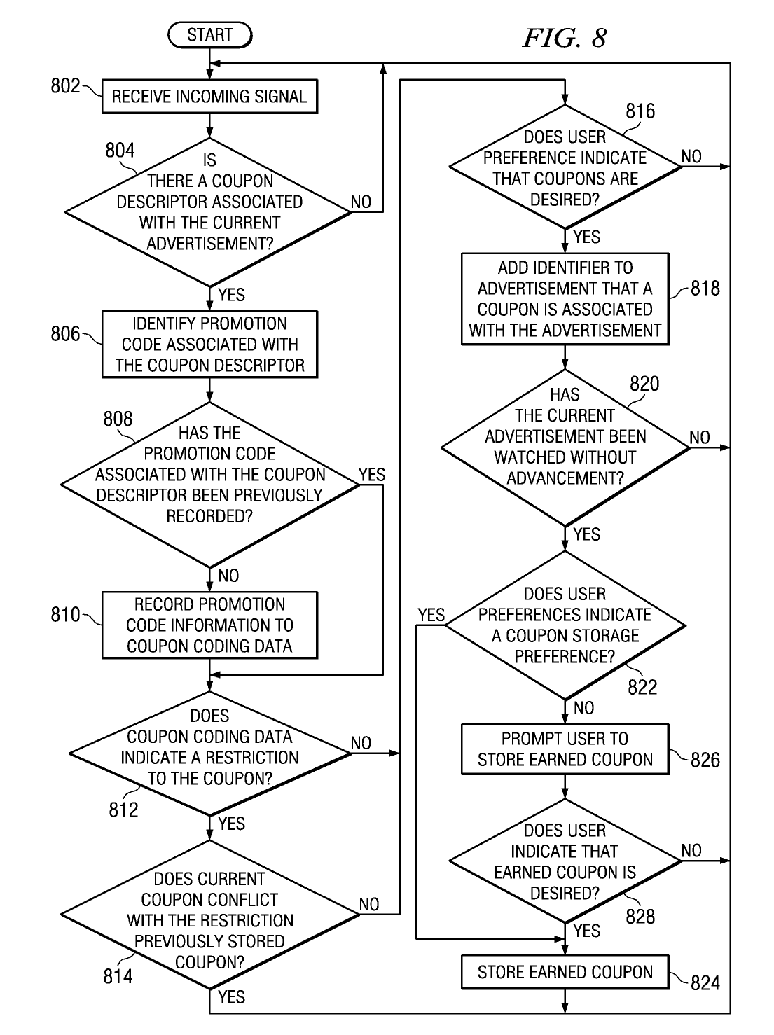

FIG. 8 depicts a flow diagram of the operation performed by a television device in obtaining a coupon in accordance with an illustrative embodiment. The operation described in FIG. 8 is performed by a television device such as television device 300 of FIG. 3. As the operation begins, a television device receives incoming signals from a network provider over a communication connection, such as wire, wireless communication links, fiber optic cables, or satellite (step 802). A coupon encoding detector within the television device determines if a current advertisement within the incoming signals includes a coupon descriptor that is digitally embedded in the advertisement (step 804). If at step 804 the coupon encoding detector does not detect a coupon descriptor included with the current advertisement, the operation returns to step 802. If at step 804 the coupon encoding detector detects a coupon descriptor within the advertisement, coupon encoding detector identifies a promotion code within the coupon descriptor (step 806).

Based on the identified promotion code, the coupon encoding detector determines whether the promotion code is recorded within the coupon coding data that is stored for all coupon descriptors (step 808). If at step 808 the promotion code associated with the coupon descriptor has not been previously recorded, the coupon encoding detector records the promotion code information in the coupon coding data (step 810). If at step 808 the promotion code associated with the coupon descriptor has been previously recorded or after the promotion code has been recorded in step 810, the coupon encoding detector references the coupon coding data to determine if the advertiser has placed a restriction on obtaining the coupon (step 812).

If at step 812 the coupon coding data indicates that a restriction on the current coupon exists, the coupon encoding detector uses the coupon coding data and stored coupon data to determine if the coupon associated with the current advertisement conflicts with a previously stored coupon (step 814). If at step 814 the current coupon conflicts with a restriction of a previously stored coupon, the operation returns to step 802. If at step 814 the current coupon does not conflict with a restriction of a previously stored coupon or if at step 812 the coupon coding data fails to indicate that a restriction on the current coupon exists, the coupon encoding detector determines if the user desires coupons of this type using the user preferences (step 816). If at step 816 the user does not desire coupons of this type, the operation returns to step 802.

However, if at step 816 the user indicates that coupons of this type are desired, the coupon encoding detector adds an identifier to an outgoing display signal which is concurrently displayed with the advertisement that a coupon is associated with (step 818). A signal advancement detector within the television device then determines if the advertisement associated with the coupon has been viewed without advancement (step 820). If at step 820 the user advances through the advertisement, no coupon is generated and the operation returns to step 802. If at step 820 the signal advancement detector acknowledges that the advertisement associated with the coupon has been viewed without advancement, a coupon generator within the television device determines, using the user's preferences, if the user has previously indicated a coupon storage preference e.g., store all coupons, store only restaurant coupons, or do not store auto coupons (step 822).

If at step 822 the user has indicated a coupon storage preference, the coupon generator stores the coupons as indicated by the user's preference (step 824). If at step 822 the user does not indicate a storage preference, coupon generator prompts the user for a desire to store the earned coupon (step 826). The coupon generator uses user input to determine whether or not to store the earned coupon (step 828). If at step 828 the user indicates the coupon is desired, the coupon generator stores the coupons as indicated by the user's preference (step 824). However, if at step 828 the user does not indicate the coupon is desired, the operation returns to step 802.

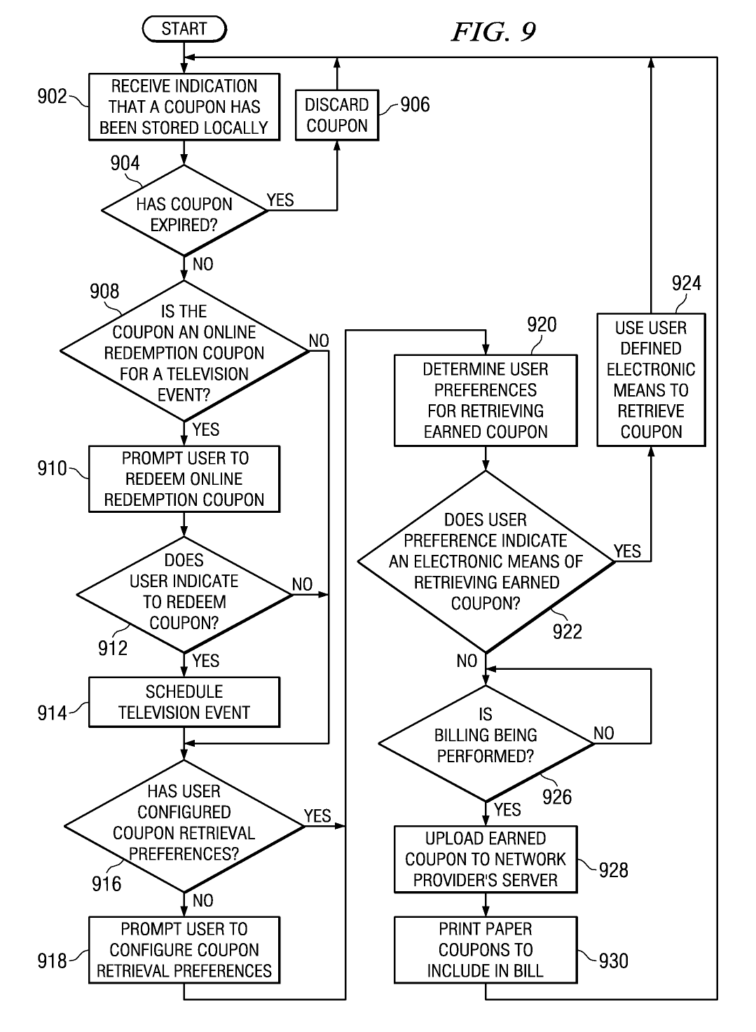

FIG. 9 depicts a flow diagram of the operation performed by a television device in administering earned coupons in accordance with an illustrative embodiment. As the operation begins, a coupon administering module receives an indication from the coupon generator that a coupon has been stored locally (step 902). As a general clean-up procedure, the coupon administering module analyzes the expiration date of each coupon in the stored coupon data to determine if the coupon has expired (step 904). If at step 904 a coupon has expired, the coupon administering module discards the coupon (step 906), with the operation returning to step 902. If at step 904 no coupon in the stored coupon data has expired, the coupon administering module determines if the coupon is an online redemption coupon for a television event (step 908).

If at step 908 the coupon is an online redemption coupon for a television event, the coupon administering module prompts the user to redeem the online redemption coupon and schedule the television event (step 910). The coupon administering module determines if the user indicates redemption of the online redemption coupon (step 912). If at step 912 the user fails to indicate the redemption of the online redemption coupon, the coupon administering module determines if the user has configured coupon retrieval preferences (step 916). If at step 912 the user indicates the redemption of the online redemption coupon, then the television device schedules the television event (step 914), with the operation proceeding to step 916. If at step 908 the coupon is not an online redemption coupon for a television event, the operation proceeds to step 916.

If at step 916 the user has not configured coupon retrieval preferences, the coupon administering module prompts the user to configure the coupon retrieval preferences within the user's preferences (step 918). If at step 916 the user has previously configured coupon retrieval preferences or once the user configures coupon retrieval preferences at step 920, coupon administering module analyzes the coupon retrieval preferences to determine the method desired by the user to retrieve the earned coupon (step 920).

Then, the coupon administering module determines, based on the coupon retrieval preferences, if the user indicates an electronic means of retrieving the earned coupon (step 922). If at step 922 the user has indicated an electronic means to retrieve the earned coupon, then the coupon administering module initializes the desired electronic method of sending the earned coupon (step 924). Exemplary electronic methods are described above in FIG. 3. For all electronic methods, the coupon administering module may send the coupons immediately or at a specific time or specific day, depending on the preferences set by the user in the user's preferences.

If at step 922 the user has not indicated an electronic means to retrieve the earned coupon, then the coupon administering module determines, based on information provided by the network service provider, if the network service provider is performing billing (step 926). If at step 926 the network service provider does not indicate that billing is being performed, the operation returns to step 926. However, if at step 926 the network service provider indicates that billing is being performed, the coupon administering module may upload the earned coupon to the network provider's server (step 928). Then, as the provider performs billing, the provider prints a paper copy of the coupon to include with any billing documentation (step 930), with the operation returning to step 902.

Thus, the illustrative embodiments provide for encouraging users to watch advertisements by providing coupons to the user if the user watches the entire advertisement. The illustrative embodiments also provide numerous means for the user to obtain their earned coupon.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for administering earned compensation offers, the method comprising:
receiving an indication that a compensation offer has been stored for a user in a data storage on a television device;
identifying a user device to which the compensation offer will be sent; and
responsive to identifying the user device, sending the compensation offer to the user device.

2. The method of claim 1, further comprising:
determining if the compensation offer is an online redemption compensation offer for a television event;
responsive to the compensation offer being the online redemption compensation offer, prompting the user to redeem the online redemption compensation offer; and
responsive to a positive indication from the user to redeem the online redemption compensation offer, scheduling viewing of the television event.

3. The method of claim 1, further comprising:
determining if the compensation offer has an expired use date; and
responsive to the compensation offer having an expired use date, discarding the compensation offer from the data storage on the television device.

4. The method of claim 1, further comprising:
responsive to a failure to identify the user device to which the compensation offer will be sent, uploading the compensation offer to a provider, wherein the provider prints the compensation offer as a paper compensation offer and wherein the paper compensation offer is included with a billing statement for the user.

5. The method of claim 1, wherein the data storage stores at least one of a compensation offer earned date, a compensation offer descriptor, a compensation offer expiration date, an advertiser identifier, or compensation offer product information.

6. The method of claim 1, wherein the user device is at least one of a desktop computer, a laptop computer, a provider server, a mobile device, or a network printer.

7. The method of claim 1, wherein the television device is at least one of a digital video recorder, a personal video recorder, a cable television receiver, or a satellite television receiver.

8. The method of claim 1, further comprising:
responsive to a failure to identify the user device to which the compensation offer will be sent, leaving the compensation offer stored in the data storage on the television device;
receiving a request from an external device to retrieve the compensation offer from the data storage; and
responsive to receiving the request, sending the compensation offer to the external device.

9. A computer program product comprising a computer useable medium having a computer readable program, wherein the computer readable program, when executed in a data processing system, causes the data processing system to:
receive an indication that a compensation offer has been stored for a user in a data storage on a television device;
identify a user device to which the compensation offer will be sent; and
responsive to identifying the user device, send the compensation offer to the user device.

10. The computer program product of claim 9, wherein the computer readable program further causes the data processing system to:
determine if the compensation offer is an online redemption compensation offer for a television event;
responsive to the compensation offer being the online redemption compensation offer, prompt the user to redeem the online redemption compensation offer; and
responsive to a positive indication from the user to redeem the online redemption compensation offer, schedule viewing of the television event.

11. The computer program product of claim 9, wherein the computer readable program further causes the data processing system to:
determine if the compensation offer has an expired use date; and
responsive to the compensation offer having an expired use date, discard the compensation offer from the data storage on the television device.

12. The computer program product of claim 9, wherein the computer readable program further causes the data processing system to:
responsive to a failure to identify the user device to which the compensation offer will be sent, upload the compensation offer to a provider, wherein the provider prints the compensation offer as a paper compensation offer and wherein the paper compensation offer is included with a billing statement for the user.

13. The computer program product of claim 9, wherein the data storage stores at least one of a compensation offer earned date, a compensation offer descriptor, a compensation offer expiration date, an advertiser identifier, or compensation offer product information, wherein the user device is at least one of a desktop computer, a laptop computer, a provider server, a mobile device, or a network printer, and wherein the television device is at least one of a digital video recorder, a personal video recorder, a cable television receiver, or a satellite television receiver.

14. The computer program product of claim 9, wherein the computer readable program further causes the data processing system to:
responsive to a failure to identify the user device to which the compensation offer will be sent, leave the compensation offer stored in the data storage on the television device;
receive a request from an external device to retrieve the compensation offer from the data storage; and
responsive to receiving the request, send the compensation offer to the external device.

15. A system, comprising:
a processor; and
a memory coupled to the processor, wherein the memory comprises instructions which, when executed by the processor, cause the processor to:
receive an indication that a compensation offer has been stored for a user in a data storage on a television device;
identify a user device to which the compensation offer will be sent; and
responsive to identifying the user device, send the compensation offer to the user device.

16. The system of claim 15, wherein the instructions further cause the processor to:
determine if the compensation offer is an online redemption compensation offer for a television event;
responsive to the compensation offer being the online redemption compensation offer, prompt the user to redeem the online redemption compensation offer; and
responsive to a positive indication from the user to redeem the online redemption compensation offer, schedule viewing of the television event.

17. The system of claim 15, wherein the instructions further cause the processor to:
determine if the compensation offer has an expired use date; and
responsive to the compensation offer having an expired use date, discard the compensation offer from the data storage on the television device.

18. The system of claim 15, wherein the instructions further cause the processor to:
responsive to a failure to identify the user device to which the compensation offer will be sent, upload the compensation offer to a provider, wherein the provider prints the compensation offer as a paper compensation offer and wherein the paper compensation offer is included with a billing statement for the user.

19. The system of claim 15, wherein the data storage stores at least one of a compensation offer earned date, a compensation offer descriptor, a compensation offer expiration date, an advertiser identifier, or compensation offer product information, wherein the user device is at least one of a desktop computer, a laptop computer, a provider server, a mobile device, or a network printer, and wherein the television device us at least one of a digital video recorder, a personal video recorder, a cable television receiver, or a satellite television receiver.

20. The system of claim 15, wherein the instructions further cause the processor to:
responsive to a failure to identify the user device to which the compensation offer will be sent, leave the compensation offer stored in the data storage on the television device;
receiving a request from an external device to retrieve the compensation offer from the data storage; and
responsive to receiving the request, send the compensation offer to the external device.
